(19) United States
(12) Patent Application Publication
(10) Pub. No.: US 2026/0237371 A1
(43) Pub. Date: Aug. 13, 2026

(54) Safe Case for Ultrasonic Voice Masking

(71) Applicant: PPIP LLC, Chandler, AZ (US)

(72) Inventor: Teddy David Thomas, Tempe, AZ (US)

(21) Appl. No.: 19/051,677

(22) Filed: Feb. 12, 2025

(51) Int. Cl. G10K 11/175; H04R 1/28; H04R 1/40

(52) U.S. Cl. CPC G10K 11/1754; H04R 1/2803; H04R 1/403; H04R 2217/03

(57) ABSTRACT

In some embodiments, an apparatus that uses ultrasonic signals to mask voice-band signals is provided. The apparatus includes a controller configured to set parameters for ultrasonic signal(s). The apparatus also includes signal generator(s), coupled with the controller, configured to generate electrical signal(s) based on the parameters. The apparatus additionally includes ultrasonic speaker(s), coupled with the signal generator(s), configured to output a first set of ultrasonic signals based on the one or more electrical signals. The apparatus further includes a housing that at least partially supports the controller, the signal generator(s), and the ultrasonic speaker(s), where the ultrasonic speaker(s) output the ultrasonic signal(s) to interfere with voice-band signals recorded by microphone(s) of electronic device(s) placed at least partially inside or near the housing.

### TECHNICAL FIELD

This relates generally to the field of privacy and security, and more specifically to an apparatus that generates ultrasonic signals to interfere with recording of voice-band signals.

### BACKGROUND

Modern consumer electronics are increasingly equipped with built-in microphones designed for sound recording. These devices often include communication capabilities, enabling them to transmit audio data to remote locations. When combined, the integration of microphones and communication modules creates a powerful system that can collect and transmit a wide range of user information. While these features are intended to enhance functionality, they also introduce significant privacy risks. Third parties, including malicious actors, can potentially exploit these microphones to intercept private conversations without the user's knowledge, raising serious concerns about eavesdropping and unauthorized access.

### BRIEF DESCRIPTION OF THE DRAWINGS

So that the present disclosure can be understood by those of ordinary skill in the art, a more detailed description can be had by reference to aspects of some illustrative embodiments, some of which are shown in the accompanying drawings.

FIG. 1 is a block diagram illustrating an exemplary safe case for ultrasonic voice masking in accordance with some embodiments;

FIGS. 2A and 2B are flowcharts illustrating randomized frequency hopping in ultrasonic voice masking in accordance with some embodiments;

FIG. 3 is a cross-sectional view of the exemplary safe case for ultrasonic voice masking in accordance with some embodiments;

FIG. 4 is a diagram illustrating an example of ultrasonic voice masking applied to multiple user equipment in accordance with some embodiments;

FIGS. 5A and 5B are diagrams illustrating various form factors of the exemplary safe case for ultrasonic voice masking in accordance with some embodiments;

FIG. 6 a diagram illustrating the effects of ultrasonic voice masking; and

FIG. 7 is a flowchart illustrating a method of ultrasonic voice masking by the exemplary safe case in accordance with some embodiments.

In accordance with common practice the various features illustrated in the drawings cannot be drawn to scale. Accordingly, the dimensions of the various features can be arbitrarily expanded or reduced for clarity. In addition, some of the drawings cannot depict all of the components of a given system, method or device. Finally, like reference numerals can be used to denote like features throughout the specification and figures.

### DETAILED DESCRIPTION

Accordingly, described herein is a safe case for privacy protection. To safeguard privacy, the safe case utilizes ultrasonic signals to jam microphones. Many modern microphones are Microelectromechanical Systems (MEMS) microphones. A MEMS microphone typically has an electro-acoustic transducer that houses a sensor and an application-specific integrated circuit (ASIC) within a single package. This integration allows mechanical structures to be miniaturized and seamlessly combined with electrical circuitry, resulting in a single physical device that functions as a system, where mechanical and electrical components work together to enable sound recording.

Ultrasonic signals, which are inaudible to nearby users, interfere with microphones, particularly MEMS microphones, preventing them from capturing clear voice recordings. In some embodiments, the safe case includes a cavity that holds one or more electronic devices equipped with microphones. Speakers embedded in the safe case emit ultrasonic signals that create interference within the voice band, causing the microphones of the electronic device(s) to experience mechanical distortion. Microphones vary in shape, size, and recording properties. In some embodiments, the safe case performs random frequency hopping within the ultrasonic range to effectively interfere with a microphone, regardless of its characteristics. Additionally, in some embodiments, the safe case can pair with the electronic device(s) to access the sound recorded by the microphones and adjust the frequency range of ultrasonic signals accordingly to ensure the recorded sound has no presence of voice snippets (e.g., no discernible voice snippets) or is rendered unintelligible.

By using ultrasonic signals for microphone jamming, the ultrasonic approach remains inaudible to human hearing, making it less obtrusive than signals in the audible range, such as pink or white noise. In some embodiments, precise speaker placement for sound masking is unnecessary, thereby reducing the cost and complexity of voice masking. Furthermore, in certain embodiments, when mechanical seals are not used around microphones or devices inside the cavity, the protection range extends beyond the safe case cavity, allowing nearby microphones outside the cavity to be jammed as well. In other embodiments, when seals are used around microphones and/or devices, the seals reduce the power requirement of the masking signal and provide passive attenuation benefits.

In some embodiments, an apparatus includes a controller configured to set parameters for one or more ultrasonic signals. The apparatus also includes one or more signal generators, coupled with the controller, configured to generate a first set of electrical signals based on the parameters. The apparatus additionally includes one or more ultrasonic speakers, coupled with the one or more signal generators, configured to output a first set of ultrasonic signals based on the one or more electrical signals. The apparatus further includes a housing that at least partially supports the controller, the one or more signal generators, and the one or more ultrasonic speakers, wherein the one or more ultrasonic speakers output the first set of ultrasonic signals to interfere with voice-band signals recorded by one or more microphones of one or more electronic devices placed at least partially inside or near the housing.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes”, “including”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when”, “upon”, “in response to determining”, or “in response to detecting”, depending on the context. Similarly, the phrase “if it is determined” or “if [a stated condition or event] is detected” is, optionally, construed to mean “upon determining”, “in response to determining”, “upon detecting [the stated condition or event],” or “in response to detecting [the stated condition or event],” depending on the context.

It should be appreciated that in the development of any actual embodiments (as in any development project), numerous decisions must be made to achieve the developers' specific goals (e.g., compliance with system and business-related constraints), and that these goals will vary from one embodiment to another. It will also be appreciated that such development efforts might be complex and time consuming, but would nevertheless be a routine undertaking for those of ordinary skill in the art of image capture having the benefit of this disclosure.

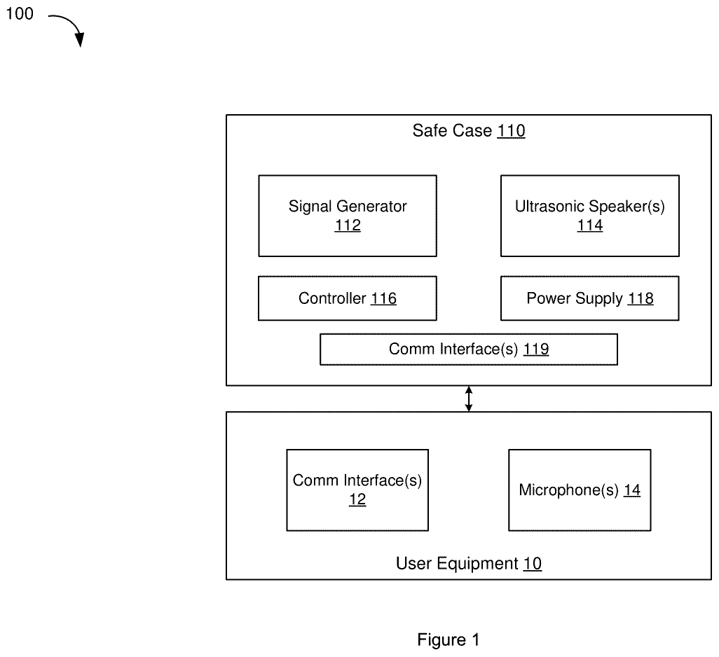

FIG. 1 is a block diagram 100 illustrating an exemplary safe case 110 for ultrasonic voice masking in accordance with some embodiments. As explained above, an exemplary user equipment 10 includes one or more communication interfaces 12 and microphones 14 that can potentially be compromised and exploited. In some embodiments, the safe case 110 includes a signal generator 112 for driving a set of electrical signals to one or more ultrasonic speakers 114, the one or more ultrasonic speakers 114, a controller 116, one or more communication interfaces 119, and a power supply 118 that provides power to the signal generator, the ultrasonic speakers 114, the controller 116, and the communication interface(s) 119. In some embodiments, the power supply 118 includes at least one of a battery, a charging socket, a USB connector, a power plug, wireless charging pad, and/or a power socket. In some embodiments, the power supply 118 can also supply power to the user equipment 10, e.g., via a wired connection or through wireless charging.

It should be noted that although a single signal generator 112, a single controller 116, and a power supply 118 are illustrated in FIG. 1, the safe case 110 may include one or more such components, e.g., multiple signal generators 112 (e.g., each driving a respective ultrasonic speaker 114), multiple controllers 116 (e.g., each controlling a respective signal generator 112), and multiple power supplies 118. For the sake of simplicity, the subject matter will be described hereinafter for the most part with reference to a single signal generator 112, a single controller 116, and a power supply 118.

In some embodiments, the user equipment 10 (also known as a consumer electronic device or an electronic device) can be a mobile or stationary device, including, but not limited to, a portable or stationary video or audio recording device, a phone, a wearable device, a computer, a TV remote, and/or a vehicle, etc. In some embodiments, the microphone(s) 14 collect audio data from the surroundings, and the communication interface(s) 12 can transmit the audio data to a remote source. In some embodiments, the microphone(s) 14 can include an audio input device and/or an audio input device integrated with a video input device. Though not shown in FIG. 1, in some embodiments, the user equipment 10 also includes an audio output device (e.g., speaker(s)), a video output device (e.g., a display), an accelerometer, a gyroscope, and/or a magnetometer (e.g., as part of an inertial measurement unit (IMU)), etc. for collecting the information of the surroundings.

In some embodiments, both the communication interface(s) 12 and 119 include a wired connection (e.g., contact point(s)), a radio frequency (RF) transceiver, a near-field communication (NFC) device, a Bluetooth (BL)/Bluetooth low energy (BLE) radio, a WiFi modem, and/or a radio-frequency identification (RFID) device for near-range and long-range communication. In some embodiments, the safe case 110 is paired with the user equipment 10 so that the safe case 110 can obtain data for privacy and security protection. For example, the safe case 110 can obtain the audio data recorded by the microphone(s) 14 via the communication interface(s) 119 and 12 for tuning of the ultrasonic voice masking described herein. Also in some embodiments, through the communication interface(s) 12 and 119, the safe case 110 can direct one or more programs executed by one or more processors or controllers on the user equipment 10 to analyze the recorded audio data, e.g., by executing an envelope detector, communicating the demodulated output, the waveform, and/or the spectrogram to the safe case 110, etc. In some embodiments, utilizing the controller 116 or a processor, the safe case 110 can execute program(s) stored in non-transitory memory of the safe case 110 to generate commands in order to control the communication interface(s) 12 and/or other output components (e.g., one or more speakers) on the user equipment 10, e.g., sending commands to turn off the communication interface(s) 12 to prevent communication by the user equipment 10, disabling the speaker(s) on the user equipment 10, etc.

In some embodiments, the safe case 110 includes a housing arranged to receive, hold, and/or attached to the user equipment 10. The housing at least partially supports the controller 116, the one or more signal generators 112, the one or more ultrasonic speakers 114, the power supply 118, and the communication interface(s) 119. Upon pairing with the user equipment 10, in some embodiments, the safe case 110 actively monitors activities on the user equipment 10, including controlling the communication path, voice masking, enabling/disabling video recording, enabling/disabling audio recording, and/or enabling/disabling video/audio output, etc. In particular, in some embodiments, the audio protection feature ensures that the audio data recorded by the microphone(s) 14 are rendered unintelligible or devoid of discernible words, as evaluated by a trained listener.

In some embodiments, for ultrasonic voice masking, the controller 116 sets parameters, e.g., duty cycles, delay, frequency ranges, etc. for the signal generator 112. The signal generator 112, e.g., a transducer driver coupled with the controller 116, then signals one or more ultrasonic speakers 114 (e.g., a single ultrasonic speaker or a transducer array) according to the parameters. In some embodiments, the signal generator 112 includes an electronic circuit for generating and providing the electrical signals according to the parameters in order to operate the ultrasonic speaker(s) 114, and the ultrasonic speaker(s) 114 then convert electrical signals from the signal generator 112 into ultrasonic sound waves. As such, the signal generator 112, coupled with the controller 116 and the ultrasonic speaker(s) 114, drives the ultrasonic speaker(s) 114 to produce the desired output by supplying certain voltages and current drew from the power supply 118 at certain frequencies according to the parameters set by the controller 116.

It should be noted that while pertinent features are illustrated, those of ordinary skill in the art will appreciate from the present disclosure that various other features have not been illustrated for the sake of brevity and so as not to obscure more pertinent aspects of the implementations disclosed herein. Those of ordinary skill in the art will also appreciate from the present disclosure that the functions of the components described herein can be combined into one or more components and/or sub-divided into additional sub-components; and, that the configurations described herein are provided as merely one example of the various configures described herein. Each of the component in the diagram 100 can include appropriate hardware, software, and/or firmware to perform the operations attributed to the element herein. Operation(s) attributed to an element in the content delivery system 100 herein should not be considered binding and in some embodiments, other element(s) in the exemplary system 100 may additionally or alternatively perform such operation(s). For example, in some embodiments, one or more of the components of the safe case 110 can be turned off or on by a button, a switch, or via a remote control. In another example, as will be described below, the safe case 110 can have various form factors and includes a lid in some embodiments, such that when the lid is open or closed, one or more of the components is automatically turned on or off, so that ultrasonic voice masking described herein can be enabled or disabled automatically.

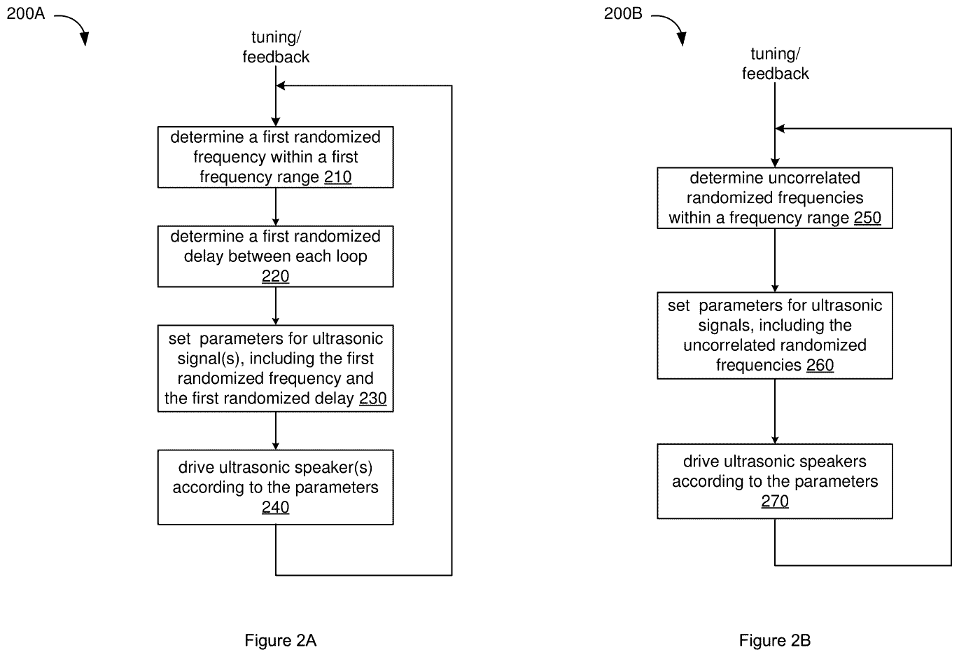

FIGS. 2A and 2B are flowcharts 200A and 200B illustrating various embodiments of randomized frequency hopping in ultrasonic voice masking. In some embodiments, the processes illustrated in the flowchart 200A and 200B are performed by the safe case 110 (FIG. 1), e.g., by the controller 116 (FIG. 1) coordinating with the signal generator 112 (FIG. 1) and the ultrasonic speaker(s) 114. In FIG. 2A, as represented by block 210, a looping process starts with the safe case (e.g., the controller 116, FIG. 1) calculating a first randomized frequency with a first predefined frequency range. For example, applying a random function, a randomized frequency within the frequency range 34-43 kHz can be derived by calculating random(34000, 43000).

Subsequently, as represented by block 220, the safe case (e.g., the controller 116, FIG. 1) determines a first randomized delay between each iteration of the loop. For example, applying a delay function, the randomized delay within a predefined time window of 1-3 ms can be calculated as delay(random(1, 3)). Having determined the randomized frequency for the ultrasonic signals and the randomized delay between each iteration of the loop, in some embodiments, the controller 116 (FIG. 1) facilitates determining corresponding voltage and current of the electrical signals corresponding to the randomized frequency and/or instructs the signal generator 112 (FIG. 1) to generate the electrical signals after the randomized delay.

In some embodiments, the safe case uses a hardware-based true random number generator (TRNG) to produce a high-entropy random seed and then uses the random seed for generating the randomized frequency. Likewise, in some embodiments, the safe case uses the TRNG to produce a random seed and then uses the random seed to generate the randomized delay within a predefined time window (e.g., 0.1-2 ms or 1-3 ms). The combination of frequency and delay randomization creates a robust and adaptive ultrasonic masking system by mitigating the predictability of interference patterns.

The process continues, as represented by block 230, with the safe case setting parameters for ultrasonic signal(s). For example, the parameters can include the randomized frequency and the randomized delay, etc. In another example, the parameters can include the duty cycle (e.g., 50%). In yet another example, the parameters can include a predefined frequency range for the ultrasonic signal(s) and a predefined time window for the randomized delay of emitting the ultrasonic signal(s) between cycles.

As represented by block 340, the safe case (e.g., the signal generator 112, FIG. 1) then drives the ultrasonic speaker(s) 114 (FIG. 1) according to these parameters. The ultrasonic speaker(s) 114 (FIG. 1) convert the electronic signals into high-frequency sound waves, inaudible to human ear, according to the set parameters. The ultrasonic signals at randomized frequency and emitted at randomized intervals interfere with voice-band signals (e.g., human speech) captured by microphones (e.g., microphone(s) 14, FIG. 1), thus disrupting the recording of audio and rendering the captured voice-band signals unintelligible or without any presence of voice snippets.

FIG. 2A illustrates that the looping process proceeds with the randomized delay introduced between the current iteration and the subsequent iteration. In the next iteration, the system determines a new randomized frequency within possibly a second predefined frequency range and a new randomized delay within possibly a second predefined time window. The safe case (e.g., the controller 116, FIG. 1) then updates the parameters such as the new randomized frequency and the new randomized delay in order to generate a second set of electrical signals to drive the ultrasonic speaker(s) accordingly. The iterative process ensures that the safe case continually adapts its output, maintaining a high level of unpredictability and effectiveness in ultrasonic voice masking.

In some embodiments, the safe case integrates tuning and feedback mechanisms to refine the parameter settings dynamically. For example, as will be described in further detail below, utilizing the communication interface(s) 119 (FIG. 1), the safe case 110 can obtain settings and configurations of the user equipment 10, e.g., model of the user equipment 10 and/or the microphone(s) 14. Accordingly, the safe case 110 can update or adjust parameters such as the predefined frequency range and/or the predefined time window based on the configurations, where the predefined frequency range and/or the predefined time window in turn are used for determining the randomized frequency and the randomized delay in each iteration of the steps in FIG. 2A. The targeted ultrasonic voice masking allows for more effective voice-band signal jamming of the user equipment 10 that can be of different configurations, types, models, and/or settings. For instance, a first ultrasonic signal generated during one iteration may be 30 kHz, which as indicated by a data mapping obtained by the safe case, provides better voice-band masking for one type of microphone, and a second ultrasonic signal generated during another iteration may be 40 kHz, which as indicated by the data mapping obtained by the safe case, provides better voice-band masking for a different type of microphone.

In another example, also utilizing the communication interface(s) 119 (FIG. 1), the safe case 110 can obtain the audio data recorded by the microphone(s) 14. By analyzing the voice data, the safe case 110 can determine the degree of voice-band signal jamming and adjust the parameters for ultrasonic voice masking accordingly. In some embodiments, the safe case 110 analyzes the audio data to determine whether the legibility of the audio data is above a threshold, e.g., utilizing an automatic speech recognizer to identify the legibility of the audio data. A high level of confidence in the automatic speech recognizer causes the controller of the safe case to update the parameters, which further causes the signal generators and the ultrasonic speakers to adjust the signals in order to make the recorded audio unintelligible or no voice presence.

In yet another example, though not show in FIG. 1, the safe case can include MEMS microphone(s) for recording ambient sound. Due to the close distance between the safe case and the user equipment, the ambient sound recorded by the microphone(s) on the safe case is similar to the sound recorded by the user equipment. In such embodiments, instead of obtaining the audio data from the user equipment, the safe case directly analyzes the recorded sound for performance tuning of the ultrasonic voice masking. For instance, the safe case can include an envelope detector for detecting an envelope or spectral shape of the audio data. By analyzing the envelope and/or the voice data and/or comparing with the voice data from the user equipment, the safe case can determine the effectiveness of voice-band signal jamming and adjust the parameters for ultrasonic voice masking accordingly.

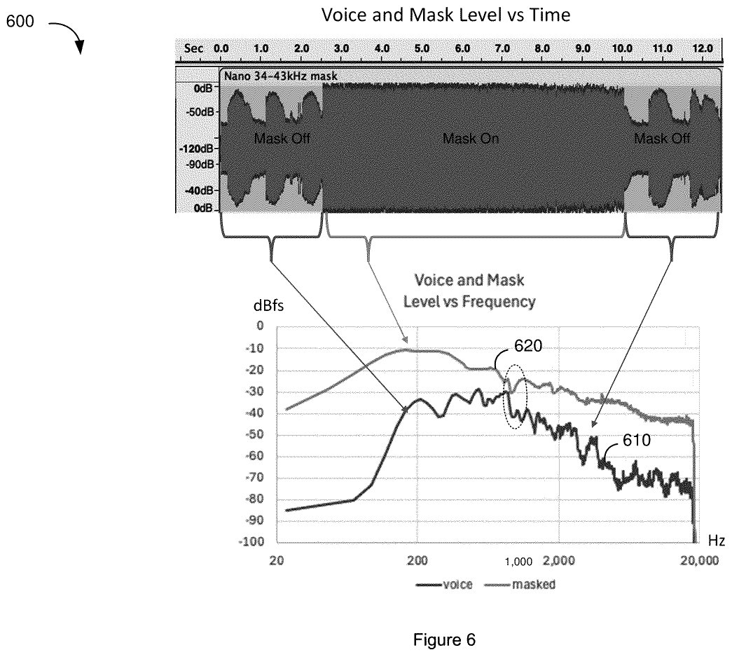

In still another example, the safe case includes microphone(s) that is not distorted by ultrasonic frequencies, e.g., a special microphone designed to monitor bat chirps up to 100 kHz and not distorted by ultrasonic frequencies as MEMS microphones. In such embodiments, by comparing the waveform of the undistorted voice with the masked voice as will be shown in FIG. 6, the safe case 110 calculates the difference and determines whether the ultrasonic masking renders the voice unintelligible (e.g., 5 to 10 dB difference) or without presence (e.g., 10 to 15 dB difference). As such, by analyzing the audio data recorded by the safe case and/or the user equipment, the safe case can determine the effectiveness of voice-band signal jamming and adjust the parameters for ultrasonic voice masking accordingly.

Using the randomized frequency hopping illustrated in FIG. 2A, the effectiveness of the ultrasonic masking system described herein lies in the dynamic nature of the configured parameters. The randomized frequency and delay ensure that the interference pattern is non-repetitive and challenging to predict. Similarly, adjusting the duty cycle provides flexibility in optimizing power usage or matching specific environmental requirements while maintaining effective disruption of voice-band recordings. The adaptive and configurable process enhances the privacy and security protection, ensuring robust protection against unauthorized audio recording. Further, feedback can be used to evaluate the efficacy of the ultrasonic interference and adjust parameters such as frequency, delay, and/or duty cycle in real time. Tuning according to the updated parameters thus maximizes interference with voice-band signals and further improves the protection against unauthorized voice recording.

As explained above with reference to FIG. 1, the safe case 110 has a housing that is arranged to received, hold, and/or attach to the user equipment 10. As such, the safe case 110 is in close distance to the user equipment 10, e.g., in the range of millimeters. Accordingly, different from conventional masking systems and methods that emits the ultrasonic signals from a distance, the safe case can perform voice masking more effectively and the adaptive voice masking is more accurate. Further, the safe case is capable of controlling sensor paths and/or communication paths associated with the user equipment, e.g., disabling the sensors and/or communication devices on the user equipment and/or re-directing the information from the user equipment. As such, the safe case can quickly adjust the voice masking to prevent the recording and/or communication of audio data, e.g., shutting down the recording and/or playback components on the user equipment, stopping the communication of the user equipment with a remote source (e.g., a remote device and/or a remote server, etc.), erasing sensitive data from the user equipment 110, adjusting the frequency hopping parameters to maximize masking sensor data, etc.

Turning to FIG. 2B, the process illustrates a randomized frequency hopping process for driving uncorrelated ultrasonic signals to multiple ultrasonic speakers. Similar to the randomized frequency hopping illustrated in FIG. 2A, a looping process includes determines parameters and driving ultrasonic speakers according to the parameters in each iteration. Different from the process illustrated in FIG. 2A, in FIG. 2B, as represented by blocks 250 and 260, the safe case (e.g., the controller 116, FIG. 1) determines uncorrelated randomized frequencies within a predefined frequency range in one pass of the iteration. These uncorrelated frequencies ensure that each ultrasonic speaker generates a distinct ultrasonic signal, maximizing the interference to voice recording by microphones of different types. Once the uncorrelated randomized frequencies are determined, the safe case sets the corresponding parameters for each ultrasonic signal, including the specific frequencies assigned to individual speakers. As shown in block 270, the safe case drives multiple ultrasonic speakers (e.g., ultrasonic speakers 114, FIG. 1) according to these parameters. By using distinct frequencies for each speaker, the system effectively creates a multi-dimensional interference field that is more resilient against countermeasures and increases the overall robustness of the ultrasonic voice masking in multi-microphone environments.

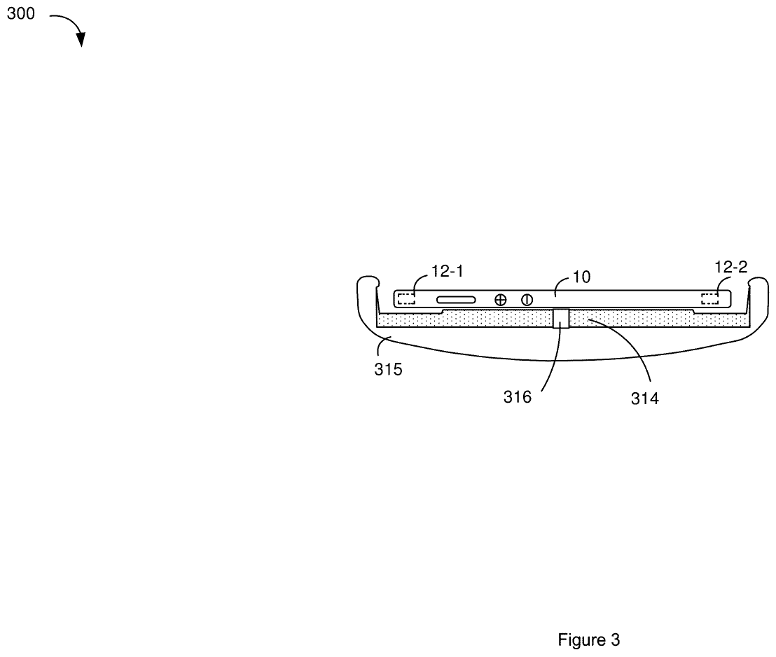

FIG. 3 is a diagram 300 illustrating a cross-sectional view of the exemplary safe case 110 (FIG. 1), in accordance with some embodiments. In some embodiments, the safe case 110 (FIG. 1) for privacy and security protection of the user equipment 10 includes a housing that forms a base portion 315. In some embodiments, the base portion 315 is made of rigid, semi-rigid, and/or structurally self-supporting materials. An inner region of the base portion 315 forms a cavity that can receive and hold the user equipment 10. Further, in some embodiments, electronic components as described above with reference to FIG. 1 are embedded in the based portion 315.

In some embodiments, at least one liner 314 covers the base portion 315. In some embodiments, the at least one liner 314 is integrated with the base portion 315, thus being part of the housing of the safe case. When the user equipment is placed inside the partial enclosure, the liner 314 is positioned between the base portion 315 and the user equipment 10. Further, in some embodiments, the at least one liner 314 has a middle rising portion to support the user equipment 10 on top. While the rising portion supports the user equipment 10 and a gap is formed between the user equipment 10 and the troughs of the liner 314. In some embodiments, the gap is within a threshold distance, e.g., the surface in the troughs is approximately 2 mm or less from the bottom of the user equipment 10.

In some embodiments, the liner 314 include an opening 316, e.g., a slot, a window, a hole, a slit, or a cutout. In the embodiments where the liner 314 is integrated with the base portion 315, the housing the safe case includes the opening 316. The opening 316 can be used for establishing connection(s) with user equipment 10 (e.g., for charging) and/or sound passing (e.g., to facilitate sound passing from the ultrasonic speakers 114, FIG. 1). Though FIG. 3 illustrates one opening 316, the liner 314 can include multiple openings. For example, in the case of the user equipment 10 includes two microphones 12-1 and 12-2, a first opening can be positioned proximate to the microphone 12-1, and the second opening can be positioned proximate to the microphone 12-2. As such, when the ultrasonic speakers embedded in the base portion 315, potentially connect to the openings, output the masking signals, such signals are directed to and fed to the microphones 12-1 and 12-2 in close distance.

It should be noted that while pertinent features are illustrated, those of ordinary skill in the art will appreciate from the present disclosure that various other features have not been illustrated for the sake of brevity and so as not to obscure more pertinent aspects of the implementations disclosed herein. Those of ordinary skill in the art will also appreciate from the present disclosure that the functions of the components described herein can be combined into one or more components and/or sub-divided into additional sub-components; and, that the configurations described herein are provided as merely one example of the various configures described herein. For example, the form factor of the safe case 110 (FIG. 1) as shown in FIG. 3 can be adapted or transformed into other form factors as a case with a lid, a button, a pin, a wand, etc. In another example, though FIG. 3 illustrates the safe case 110 holding one user equipment 10, the cavity of the safe case 110 can hold more than one user equipment 10.

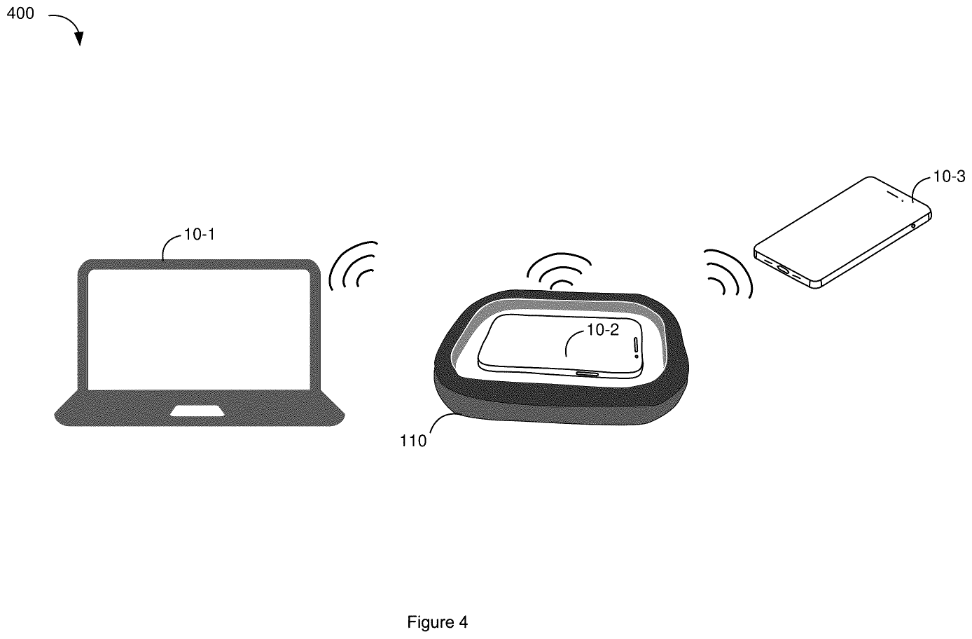

FIG. 4 is a diagram 400 illustrating an example of ultrasonic voice masking applied to multiple user equipment 10-1, 10-2, and 10-3 in accordance with some embodiments. In FIG. 4, one user equipment 10-2 (e.g., a phone with one or more microphones) is placed inside the cavity of the safe case 110, while other devices, such as user equipment 10-1 (e.g., a computing device with one or more microphones) and 10-3 (e.g., another phone that is of a different model with one or more microphones) are situated, placed, or positioned near the safe case 110 but remain outside its cavity.

As described above with reference to FIGS. 2A and 2B, the safe case 110 generates randomized ultrasonic signals using randomized frequency hopping. In some embodiments, the safe case 110 directs the randomized ultrasonic signals to a general area, e.g., using a form factor shown in FIG. 3. The ultrasonic signals not only jam the microphones of the user equipment 10-2 placed inside the cavity of the safe case 110 but also effectively disrupt the microphones on the nearby user equipment 10-1 and 10-3 located within the general vicinity of the safe case 110. Further as described above with reference to FIG. 2B, in some embodiments, the safe case 110 includes multiple ultrasonic speakers 114 (FIG. 1), e.g., a transducer array, each of the ultrasonic speakers 114 (FIG. 1) emits uncorrelated ultrasonic signals that can mask different voice bands and/or generate better masking results for different user equipment 10 having different types of microphones. In some embodiments, when the safe case 110 includes one ultrasonic speaker 114 (FIG. 1), as described above with reference to FIG. 2A, the randomized frequency hopping in each loop provides masking of voice-band signals at different frequencies and the randomized frequency and delay in each loop is uncorrelated with the randomized frequency and delay in another loop, thus ensuring masking of different microphones on different user equipment 10-1, 10-2, and 10-3.

The exemplary safe case 110 shown in FIG. 4 does not rely on a lid to seal the audio pathway in order to mask voice-band signals. The broad-spectrum approach described herein in accordance with various embodiments eliminates the necessity of designing custom seals to match specific microphone configurations of individual devices. For example, previously existing designs required precisely aligning openings or seals with microphone placements on different phone models, a time-consuming and costly endeavor. Removing the reliance on custom seals reduces development time and production costs while enhancing compatibility across various device models. Moreover, as in some embodiments, as described above with reference to FIGS. 2A and 2B, the randomized frequency hopping ensures that ultrasonic interference is effective for multiple user equipment devices 10 simultaneously, regardless of their specific physical attributes and/or microphone placements. Such flexibility enhances the practicality and scalability of the safe case 110 in diverse operational scenarios.

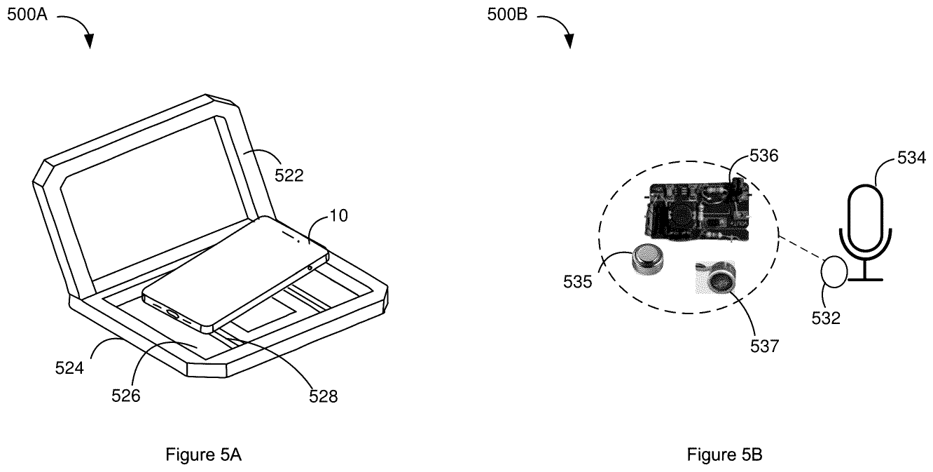

FIGS. 5A and 5B are diagrams 500A and 500B illustrating various form factors of the safe case 110 (FIG. 1) for ultrasonic voice masking, in accordance with some embodiments. In FIG. 5A, in some embodiments, the housing of the safe case includes an assembly, which further includes a first housing portion 522 (e.g., a lid or a cover) and a second housing portion 524 (e.g., a base). In some embodiments, the first housing portion 522 and/or the second housing portion 524 are made of rigid, semi-rigid, and/or structurally self-supporting materials. In some embodiments, the second housing portion 524 is similar to the safe case illustrated in FIG. 3, e.g., including a based portion 526 providing a cavity and one or more liners 528 placed inside the cavity and forming one or more rising portions to support the user equipment 10. Also similar to the embodiment described with reference to FIG. 3, in FIG. 5A, electronic components (e.g., the signal generator 112, the ultrasonic speakers 114, the controller 116, the power supply 118, and the communication interface(s), etc. in FIG. 1) are embedded in the based portion 526. Additionally similar to the embodiment described with reference to FIG. 3, though FIG. 5A illustrates the safe case 110 holding one user equipment 10, the safe case 110 can hold more than one user equipment 10.

In some embodiments, the assembly shown in FIG. 5A can be at least partially removed, adjusted, opened, or closed to adjust a level of the privacy and/or security protection. For example, the first and second housing portions 522 and 524 can form an enclosure, such that the top shell is in contact with the lower shell and the enclosure is formed by closing together the top shell and bottom shell. When the lid or the cover is open as shown in FIG. 5A, an inner region (also known as an enclosure) can receive and hold the user equipment 10. When the lid or the cover is closed, the assembly can at least partially block sensing and/or communication capabilities of the enclosed user equipment 10.

Further, when the lid or the cover is closed, the assembly provides passive attenuation, such as preventing, reducing, or limiting the sound recording of the surrounding outside the enclosure by the microphones on the user equipment 10. Though not shown in FIG. 5B, in some embodiments, the first housing portion 522 and/or the second housing portion 524 include at least partial sealing that forms an environmental barrier to attenuate or at least partially block the propagation of acoustic signal. As such, when the lid or cover is closed, the physical barrier formed by the sealing structure provides further passive acoustical shielding and/or attenuation. By closing the lid in conjunction with the optional sealing structure, there is a higher level of passive attenuation of the spoken voice outside the safe case from being recorded by the user equipment 10 enclosed inside the safe case.

For conventional passive voice attenuation, the entire enclosure would require a special sealed design. This is due to the low frequency voice waveforms that vibrate a flat surface and take advantage of even very tiny air leaks. In contrast, the ultrasonic voice masking described herein includes active masking in addition to passive attenuation. The primary mechanism of active voice masking is increased when the lid is closed due to resonance inside the enclosure. Ultrasonic bounces more than it penetrates so the lid serves to increase the internal energy, thereby reducing external energy and decreasing the interference of devices outside but near the safe case. In some embodiments, when the lid is closed, the controller of the safe case updates the parameters for the ultrasonic signals to conserve energy while maintaining the same amount of ultrasonic voice masking, e.g., increasing the randomized delay, decreasing the voltage and/or current of the electrical signals, etc.

In FIG. 5B, the safe case 110 (FIG. 1) is in the form factor of a button 532 or a pin that can be attached to or placed in proximity to a user equipment, such as microphone 534. The button 532 has a housing encapsulating the electronic components shown in FIG. 1, such as a coin cell battery 535 (e.g., as the power supply 118, FIG. 1), a chip 536 (e.g., providing the signal generator 112 and/or the controller 116 function, FIG. 1), and a transducer 537 (e.g., as the ultrasonic speaker(s) 114, FIG. 1). The small form factor of the safe case 232 makes it easy to be applied to different microphones to perform the ultrasonic voice masking described herein. Further, similar to the embodiment described with reference to FIG. 3, though FIG. 5B illustrates the button 532 generates ultrasonic signals to interfere with the voice recording by a single microphone 534, the ultrasonic signals can interfere with more than one user equipment nearby, e.g., additional microphone(s), phones, and/or computing device(s) with build-in microphone(s) nearby.

The ultrasonic voice masking described herein enables the safe case to emit ultrasonic signals that effectively mask normal conversations, background music, and similar audio (e.g., at sound levels of approximately 60 dB). As a result, such sounds are rendered absent from the recorded audio data, as judged by trained listeners, creating the impression that no voice snippets were present. For louder sounds-such as shouting, vacuum cleaners, loud music, heavy traffic, window air conditioners, or power lawn mowers-the ultrasonic masking ensures the recorded audio is unintelligible, making it impossible for a trained listener to discern individual words or meaning.

For example, FIG. 6 presents a diagram 600 demonstrating the effects of ultrasonic voice masking. The top graph shows a spectrogram for an audio recording over approximately 12 seconds, during which the user is giving a speech. The waveform in the top graph represents the signal level (dB) versus time (seconds). Between 0 and 3 seconds, and again from 10 to 12 seconds, the masking signal is off. The masking signal is on between the 3-second and 10-second marks, which correlates to the masking level represented by the masked line 620 in the bottom graph of FIG. 6.

In the bottom graph of FIG. 6, shown along the Y-axis, refers to decibels relative to full scale, a unit of measurement for digital audio signal levels. As is known in the art, a decibel (dB) is a ratio between two quantities reported on a logarithmic scale, allowing a realistic model of human auditory perception, with the human ear reacting to relative changes in noise level. In many cases, dB is followed by a suffix to define a reference variable, such as dBfs. For example, dBA represents weighted decibels, where each value has a different gain depending on the frequency to better reflect human auditory perception. At 1 kHz, dBA is approximately the value of dBfs plus 120.

In FIG. 6, the bottom graph shows two lines: the voice line 610 and the masked voice line 620. The voice at a 1 kHz frequency is around 40 dBfs, which corresponds to 80 dBA, e.g., −40 dBfs+120=80 dBA. In some embodiments, the specification for intelligibility is defined as 90 dBA, while for presence, it is 80 dBA at 1 kHz. Intelligibility refers to the ability to discern speech, such as understanding individual words, whereas presence refers to detecting word-like sounds or voice snippets without comprehension. Thus, without masking, at represented by the voice line 610, the unmasked speech at 1 kHz exhibits presence.

In some embodiments, for mask level margin, the difference between the masked voice and the original voice is 10 to 15 dB for presence and 5 to 10 dB for intelligibility. For example, around 1 kHz as indicated by the dashed circle, the masked voice is around 30 dB and the original voice is around 40 dB. The difference between the two around 1 kHz is approximately 10 dB, thus masking the presence of the voice at 1 kHz. In the example shown in FIG. 6, the difference between the voice line 610 and the masked voice line 620 is greater than 10 dB across most frequencies, effectively drowning out the original voice. FIG. 6 illustrates that when the masking signal exceeds the voice level across all bands (as shown in both the top and bottom graphs), it effectively masks the human voice across the full frequency range (approximately 20 Hz to 20 kHz), as depicted in the bottom graph. By applying the randomized frequency-hopping approach described herein, the system reliably obscures voice recordings and other audio inputs, ensuring robust privacy and security in various environments.

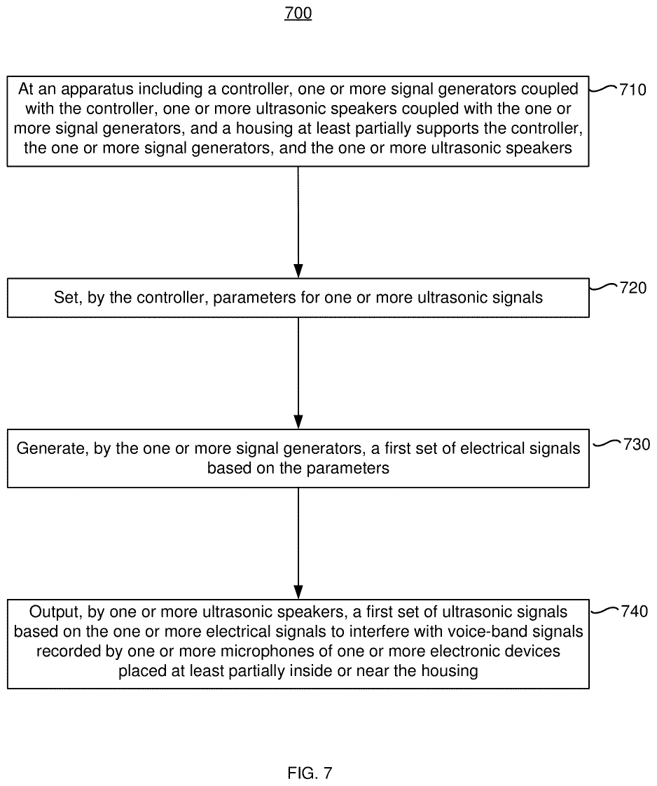

FIG. 7 is a flowchart illustrating a method 700 of ultrasonic voice masking in accordance with some embodiments. In some embodiments, as represented by block 710, the method 700 is performed at an apparatus (e.g., the safe case 110, FIGS. 1 and 4) that includes a controller (e.g., the controller 116, FIG. 1), one or more signal generators (e.g., the signal generator 112, FIG. 1) coupled with the controller, one or more ultrasonic speakers (e.g., the ultrasonic speaker(s) 114, FIG. 1) coupled with the one or more signal generators, and a housing (e.g., the housing 315 in FIG. 3, the base 524 and the lid 522 in FIG. 5A, and/or the shell of the safe case 532 in FIG. 5B) at least partially supports the controller, the one or more signal generators, and the one or more ultrasonic speakers.

As represented by block 720, the method 700 includes setting, by the controller, parameters for one or more ultrasonic signals, e.g., step 230 in FIG. 2A and/or step 260 in FIG. 2B. The method 700 further includes, as represented by block 730, generating, by the one or more signal generators, a first set of electrical signals based on the parameters, and outputting, by one or more ultrasonic speakers, a first set of ultrasonic signals based on the one or more electrical signals to interfere with voice-band signals recorded by one or more microphones of one or more electronic devices placed at least partially inside or near the housing, as represented by block 740.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. An apparatus comprising:
a controller configured to set parameters for one or more ultrasonic signals;
one or more signal generators, coupled with the controller, configured to generate a first set of electrical signals based on the parameters;
one or more ultrasonic speakers, coupled with the one or more signal generators, configured to output a first set of ultrasonic signals based on the one or more electrical signals; and
a housing at least partially supports the controller, the one or more signal generators, and the one or more ultrasonic speakers, wherein the one or more ultrasonic speakers output the first set of ultrasonic signals to interfere with voice-band signals recorded by one or more microphones of one or more electronic devices placed at least partially inside or near the housing.

2. The apparatus of claim 1, wherein:
the parameters include a randomized frequency for the first set of ultrasonic signals; and
the controller is further configured to facilitate determining corresponding voltage and current of the first set of electrical signals corresponding to the randomized frequency.

3. The apparatus of claim 1, wherein:
the parameters include a randomized delay; and
the controller is further configured to instruct the one or more signal generators to generate the one or more electrical signals after the randomized delay.

4. The apparatus of claim 1, wherein:
the controller is further configured to update the parameters;
the one or more signal generators are further configured to generate a second set of electrical signals based on the updated parameters; and
the one or more ultrasonic speakers is further configured to output a second set of ultrasonic signals based on the second set of electrical signals, wherein the second set of ultrasonic signals is different from the first set of ultrasonic signals.

5. The apparatus of claim 1, further comprising:
a hardware-based true random number generator configured to produce a random seed.

6. The apparatus of claim 5, wherein:
the controller is further configured to use the random seed to generate a randomized frequency and a randomized delay for the first set of ultrasonic signals.

7. The apparatus of claim 1, wherein:
the one or more signal generators are further configured to use randomized numbers to generate uncorrelated electrical signals as the first set of electrical signals, wherein the uncorrelated electrical signals correspond to uncorrelated ultrasonic signals as the first set of ultrasonic signals.

8. The apparatus of claim 1, wherein:
the one or more signal generators is further configured to concurrently drive a first electrical signal of the uncorrelated electrical signals to the first ultrasonic speaker and a second electrical signal of the uncorrelated electrical signals corresponding to a second ultrasonic signal to the second ultrasonic speaker, wherein the first ultrasonic signal has uncorrelated frequency from the second ultrasonic signal.

9. The apparatus of claim 1, wherein:
the one or more signal generators is further configured to drive a first electrical signal corresponding to a first ultrasonic signal at a first frequency and drive a second electrical signal at a second frequency, different from the first frequency, after a randomized delay.

10. The apparatus of claim 1, wherein:
the parameters include a predefined frequency range for the first set of ultrasonic signals and a predefined time window for randomizing generating the first set of electrical signals.

11. The apparatus of claim 1, further comprising:
a communication interface, at least partially supported by the housing and coupled with the controller, communicatively coupled with the one or more electronic devices.

12. The apparatus of claim 11, wherein the controller is further configured to:
obtain, via the communication interface, configurations of the one or more microphones on the one or more electronic devices; and
updating the parameters based on the configurations.

13. The apparatus of claim 11, wherein the controller is further configured to:
obtain, via the communication interface, audio data recorded by the one or more microphones;
determine whether legibility of the audio data above a threshold; and
update the parameters to cause the one or more signal generators to adjust the first set of electrical signals in response to determining the legibility of the audio data is above the threshold.

14. The apparatus of claim 13, further comprising:
a microphone, configured to record ambient sound undistorted by the first set of ultrasonic signals,
wherein determining whether legibility of the audio data above the threshold includes comparing the ambient sound with the audio data, and determining whether a difference between the ambient sound and the audio data is above a threshold.

15. The apparatus of claim 1, further comprising:
a microphone, configured to record audio data; and
an envelope detector, configured to detect an envelope of the audio data,
wherein the controller is further configured to adjust the parameters based on the envelope.

16. The apparatus of claim 1, wherein the housing provides a cavity arranged to receive and hold the one or more electronic devices.

17. The apparatus of claim 1, wherein the housing is a housing assembly and includes a lid, wherein the lid, when closed, encloses the one or more electronic devices inside the housing.

18. The apparatus of claim 1, further comprising:
one or more openings, connected to the one or more ultrasonic speakers, wherein the one or more openings include seals to direct the first set of ultrasonic signals from the one or more ultrasonic speakers to the one or more microphones.

19. The apparatus of claim 1, further comprising a switch, at least partially supported by the housing, configured to turn on or off at least one of the controller, the one or more signal generators, or the one or more ultrasonic speakers.

20. A method comprising:
at an apparatus including a controller, one or more signal generators coupled with the controller, one or more ultrasonic speakers coupled with the one or more signal generators, and a housing at least partially supports the controller, the one or more signal generators, and the one or more ultrasonic speakers:
setting, by the controller, parameters for one or more ultrasonic signals;
generating, by the one or more signal generators, a first set of electrical signals based on the parameters; and
outputting, by one or more ultrasonic speakers, a first set of ultrasonic signals based on the one or more electrical signals to interfere with voice-band signals recorded by one or more microphones of one or more electronic devices placed at least partially inside or near the housing.
